(19) United States
(12) Patent Application Publication
(10) Pub. No.: US 2008/0217258 A1
(43) Pub. Date: Sep. 11, 2008

(54) Treatment of water

(75) Inventor: Peter James Buchan, Johannesburg (ZA)

Correspondence Address: LADAS & PARRY LLP, 26 WEST 61ST STREET, NEW YORK, NY, 10023, US

(73) Assignee: PPA WATER INDUSTRIES (PTY) LIMITED

(21) Appl. No.: 12/074,698

(22) Filed: Mar. 5, 2008

Related U.S. Application Data
(63) Continuation-in-part of application No. PCT/IB2006/053129, filed on Sep. 6, 2006.

(30) Foreign Application Priority Data
Sep. 7, 2005 (ZA) 2005/07196
Dec. 1, 2005 (ZA) 2005/09746
Mar. 24, 2006 (ZA) 2006/02432
Jun. 14, 2006 (ZA) 2006/04921
Apr. 11, 2007 (ZA) 2007/02970

(51) Int. Cl. C02F 1/68; B67D 5/06

(52) U.S. Cl. 210/747; 222/192

(57) ABSTRACT

A method of treating water includes introducing a chemical dispenser containing a water treatment substance, into a body of water so that the dispenser is located at a first level in the water. Water enters the dispenser through an aperture with the water coming into contact with the water treatment substance, and an active ingredient thus being released into the water. Active ingredient is thereby dispersed into the body of water at the first level. The dispensing of active ingredient into the body of water at the first level is continued for a period of time. Thereafter, the dispenser is allowed to rise to a second higher level in the body of water. For a further period of time, active ingredient is dispensed from the dispenser into the body of water at the second level.

This application is a continuation-in-part of International Application PCT/IB2006/053129 filed on 6 Sep. 2006, which designated the USA, claims the benefit thereof and incorporates the same by reference.

THIS INVENTION relates to the treatment of water. It relates in particular to a method of treating water, and to a chemical dispenser for dispensing an active ingredient into water.

The Applicant is aware of surface floating chemical dispensers for treating water, such as swimming pool water. These dispensers float at the surface of the water, and contain a water treatment substance which, when water is brought into contact therewith, releases an active ingredient which is capable of treating, eg sanitizing, the water. The dispensers thus have openings through which water enters so as to contact the water treatment substance, with the active ingredient being released into the water. However, these surface floating dispensers have drawbacks such as being unsightly and providing inadequate dosing of active ingredient throughout the swimming pool. It is thus an object of this invention to provide a dispenser whereby these drawbacks are at least reduced.

In this specification, ‘water treatment substance’ means a chemical substance or composition which is capable of releasing, when water is brought into contact with it, an active ingredient capable of treating the water.

According to a first aspect of the invention, there is provided a method of treating water, which method includes
introducing a chemical dispenser containing a water treatment substance, into a body of water so that the dispenser is located at a first level in the water;
allowing water to enter the dispenser through an aperture so that the water comes into contact with the water treatment substance, with an active ingredient being released into the water, thereby dispensing active ingredient into the body of water at the first level;
continuing the dispensing of active ingredient into the body of water at the first level for a period of time;
thereafter, allowing the dispenser to rise to a second higher level in the body of water; and
for a further period of time, dispensing active ingredient from the dispenser into the body of water at the second level.

The body of water may be contained in a reservoir. The first level may be in proximity to a floor of the reservoir, while the second level may be in proximity to the surface of the water in the reservoir.

The periods of time that the active ingredient is dispensed into the water at the first and second levels may, in each case, be at least several days, and may even be as long as 1 to 3 weeks.

The reservoir may, in particular, be a swimming pool, and the active ingredient will thus be suitable for treating, eg sanitizing, swimming pool water. The active ingredient may be a halogen, particularly chlorine. The dispenser will thus contain a water treatment substance capable of releasing chlorine into the water, on water contacting the water treatment substance. The water treatment substance may be in the form of one or more tablets whose initial mass is sufficient to cause the dispenser to sink when introduced into the water.

The water treatment substance may thus be, or include, a rapid release compound such as calcium hypochlorite and/or a slow release compound such as trichloroisocyanuric acid.

The dispenser may be of elongate form, and the method may include orientating it vertically, or allowing it to orientate vertically, in the water at the first and second levels.

The chlorine, or chlorine-containing water, may be dispensed through a plurality of apertures in the dispenser. In particular, water from the swimming pool may enter the dispenser through the apertures and contact the water treatment substance, thereby causing chlorine to be released, with the chlorine, or water containing chlorine, then passing from the dispenser through the apertures, so that the water in the swimming pool is thereby dosed with chlorine.

The apertures may be spaced longitudinally apart on the dispenser.

The method may include, when the dispenser is at the first level, preventing water from entering or leaving the dispenser through an operatively lower primary aperture while, when the dispenser is at the second level, permitting water also to enter or leave the dispenser through the primary aperture.

The primary aperture may be closed off with a closure member which moves from a closed position in which it closes off the primary aperture, to an open position in which the primary aperture is exposed, as the dispenser moves from the first level to the second level.

In one embodiment of the invention, the method may include, at the second level, also dispensing a conditioning agent from the dispenser into the body of water. The period of time that the active ingredient, ie chlorine, is dispensed into the water at the first level may then be less than 5 hours, typically 1 to 2 hours, while the period of time that the chlorine is dispensed at the second level may then be less than 10 hours, typically 3 to 4 hours.

The period of time that the conditioning agent is dispensed into the water may be less than a day, typically 7 to 12 hours.

The Applicant has found that swimming pools intermittently require additional doses of chlorine, ie over and above the normal daily doses of chlorine that are used, for example so as to kill off algal growth, to compensate for increased chlorine demand due to rain, increased bather loads, etc, and to oxidize organic waste. Such additional chlorine dosage is known as ‘super-chlorination’ or ‘shock treatment’. This can be achieved with the method according to this embodiment of the invention.

The conditioning agent may be a filtration aid, eg a flocculating agent such as aluminium sulphate, polyacrylamide or the like, which, when dispensed into the water at the second level, serves to condition the water thereby to assist in filtering out the products obtained through shock treatment with the chlorine such as dead algal cells or complexed chemical matter.

The conditioning agent may be in powder, granular or kibble (large particles up to 25 mm in size or diameter) form, and may also be contained inside a perforated bag. The perforated bag will assist in retarding dissolution of the conditioning agent when the dispenser is at the first level, ie while initial shock treatment with chlorine is being effected.

The chlorine, or chlorine-containing water, and dissolved conditioning agent may be dispensed through a plurality of apertures in the dispenser. In particular, water from the swimming pool may enter the dispenser through the apertures and contact the water treatment substance, thereby causing chlorine to be released, with the chlorine, or water containing chlorine, then passing from the dispenser through the apertures, so that the water in the swimming pool is thereby dosed with chlorine. The same applies in respect of the conditioning agent; however, water containing dissolved conditioning agent may also, or instead, be dispensed through an aperture at the bottom of the dispenser.

The apertures may be spaced longitudinally and/or peripherally apart on the dispenser.

The dispenser may be as hereinafter described, with reference to the second aspect of the invention.

According to a second aspect of the invention, there is provided a chemical dispenser for dispensing an active ingredient into water, the chemical dispenser including
a buoyant dispenser body providing an enclosed cavity and having at least one aperture which provides access to the cavity, or at least one aperture defining means; and
a water treatment substance inside the dispenser body cavity, with the cavity containing sufficient water treatment substance such that the dispenser sinks when introduced into water.

In use, the dispenser will thus, when introduced into a body of water, sink to a first level, with water entering the body through the aperture and coming into contact with the water treatment substance, so that active ingredient is released by the water treatment substance into the water, and with the water treatment substance thus being consumed; after consumption of some of the water treatment substance, the dispenser then rises to a second higher level at which active ingredient is dispensed for a further period of time.

The dispenser body may be of hollow elongate form, having an operatively lower first end portion and an operatively upper second end portion. Buoyancy imparting means may be provided at or near the operatively upper second end portion of the dispenser body. The buoyancy imparting means may be a buoyant substance, such as foamed polystyrene or the like; a pocket of air; or the like. The inside of the dispenser body thus constitutes the enclosed cavity.

The first end portion of the dispenser body may be pointed or rounded, ie it may be provided with a pointed or rounded end which, in use, will rest on a floor of a reservoir containing the water, when the dispenser is at the first level. Thus, for example, the first end portion of the body may taper downwardly inwardly.

The water treatment substance may be as hereinbefore described, and may be in the form of a plurality of tablets located inside the dispenser body.

Preferably, the dispenser body includes a sleeve-like or cylindrical portion, between the first and second end portions. The sleeve-like or cylindrical portion may be circular in cross-section.

A plurality of primary water treatment substance tablets may be provided. The primary tablets may be circular in plan view, and their diameters may be of the same order of magnitude as that of the cylindrical portion of the dispenser body. The primary tablets may thus be stacked one above the other inside the cylindrical portion of the dispenser body, in proximity to its first end portion.

Each primary tablet may comprise from 90% (by mass) to 100% (by mass) trichloroisocyanuric acid, and from 0% to 10% (by mass) flocculant, such as aluminium sulphate. Thus, for example, some of the primary tablets may consist of trichloroisocyanuric acid, with the remainder of the primary tablets comprising a mixture of trichloroisocyanuric acid, a flocculant, and sodium chloride. Each primary tablet may further include a chemical which speeds up dissolution of the primary tablet, for example, sodium chloride. Therefore, each primary tablet may comprise from 85% (by mass) to 100% (by mass) trichloroisocyanuric acid, and from 0% (by mass) to 15% (by mass) flocculant, such as aluminium sulphate, and sodium chloride.

A plurality of secondary water treatment substance tablets, which are smaller than the primary tablets, and which are located between the primary tablets and the buoyancy imparting means, may also be provided. Since the secondary tablets are smaller than the primary tablets, there are voids between adjacent secondary tablets. These voids, which, in use, will thus be filled with water, assist in maintaining the dispenser uprightly in the water. It is to be appreciated that, if desired, the smaller secondary tablets can be dispensed with; thus, the voids between adjacent secondary tablets are not, in all embodiments of the invention, essential for proper upright functioning of the dispenser.

Each secondary table may comprise, or consists of, trichloroisocyanuric acid.

In one embodiment of the invention, a plurality of primary apertures may be provided in the cylindrical portion of the dispenser body, in proximity to its first end portion. A plurality of secondary apertures may be provided in the cylindrical portion of the dispenser body, between the primary apertures and the buoyancy imparting means, eg in proximity to the secondary tablets.

However, in another embodiment of the invention, a single operatively downwardly directed primary aperture may be provided at the first end of the dispenser body. The dispenser may then include valve means for closing off the primary aperture when the dispenser is located at the first level in a body of water, while the valve means will allow the primary aperture to be exposed or uncovered when the dispenser is at the second level.

The valve means may comprise an externally located plug for closing off the primary aperture, a stem protruding from the plug through the primary aperture into the inside of the container body, and a retaining component protruding from the stem, for holding the plug and stem captive relative to the dispenser body. The stem can thus move relative to the dispenser body, and the plug will be of relatively dense material, ie denser than water. Thus, when the dispenser is located at the first level, the plug will rest on the floor of the reservoir and will thus be urged into contact with the dispenser body around the primary aperture, thereby closing off the primary aperture; however, when the dispenser rises to the second level, the density of the plug will cause it to move downwardly relative to the dispenser body, thereby uncovering the primary aperture.

The dispenser may include an upwardly outwardly flaring skirt around the dispenser body, immediately below the secondary apertures, or the secondary aperture defining means.

In one embodiment of the invention, the chemical dispenser may include a first end piece closing off the first end of the cylindrical portion, a second end piece closing off the second end of the cylindrical portion, a primary aperture in the first end piece, at least one secondary aperture in the cylindrical portion, openable closure means closing off the primary aperture, and bias means biasing the closure means into contact with the first end piece, thereby to seal off the primary aperture, with the bias means being associated with the tablet so that, in use, as the tablet is consumed, the bias imparted by the bias means on closure means reduces.

In use, the dispenser of this embodiment, when introduced into a body of water, is orientated vertically with its first end lowermost; the bias means ensures that the closure member closes off the primary aperture. The dispenser sinks to a first level. Water enters the body through the secondary aperture and comes into contact with the tablet. Active ingredient is released by the water treatment substance into the water for a period of time, and the tablet is thus consumed. After consumption of sufficient of the tablet, the dispenser rises to a second higher level at which active ingredient is dispensed for a further period of time. As the tablet is consumed, the bias that the bias means exerts on the closure member is reduced. When sufficient of the tablet has been consumed, a point will be reached where the bias means no longer exerts any significant bias on the closure member. This will permit the closure member to unseat from the primary aperture under gravity, thereby exposing the primary aperture and permitting treated water to exit the body also through the primary aperture. It will be appreciated that the tablet will be sized so that unseating of the closure member from the primary aperture will only occur after the dispenser has risen to the second level.

The first end of the dispenser body may, in use, rest on a floor of the reservoir, when the dispenser is at the first level. This may assist in ensuring that the closure means seals off the primary aperture when the dispenser is located at the first level.

The closure or valve means may then comprise an externally located closure member closing off the primary aperture; a stem protruding from the closure member through the primary aperture into the inside of the container body and through an aperture in the tablet; and a retaining component at the free or distal end of the stem, for trapping the distal end of the stem inside the dispenser body. The stem and closure member can thus move relative to the apertured tablet and the dispenser body, and the closure member will be of relatively dense material, ie denser than water. Thus, when the dispenser is located at the first level, the closure member will rest on the floor of the reservoir and will thus be urged into contact with the dispenser body around the primary aperture, thereby ensuring that it closes the primary aperture; however, when the dispenser rises to the second level, the density of the closure member (once sufficient of the tablet has been consumed so that the bias means no longer biases the closure member into contact with the first end of the body) will cause it to move downwardly relative to the dispenser body, thereby uncovering the primary aperture. The bias means may be provided between the retaining component of the closure means and the operatively upper surface of the tablet, and is such that it urges the retaining component away from the tablet.

Instead, the bias means may then be in the form of a spring.

The closure or valve means may then comprise an externally located closure member closing off the primary aperture; a stem protruding from the closure member through the primary aperture into the inside of the container body and through aligned apertures in a plurality of the primary tablets; a spring bearing member around the stem and resting on an operatively upper surface of the lowermost primary tablet(s), with the spring bearing member and the stem being movable relative to each other; a cap or end piece attached to the distal end of the stem, with the cap or end piece also located within the apertures or central openings of the primary tablets; and with the spring being located around the stem and sandwiched between the cap or end piece and the spring bearing member, and being under compression.

In one embodiment of the invention, the chemical dispenser may include a water conditioning agent inside the dispenser body, with sufficient water treatment substance and water conditioning agent initially being present inside the dispenser body so that the dispenser sinks when introduced into water, but with the dispenser body having sufficient buoyancy so that it will float at the water surface while it still contains some water treatment substance and water conditioning agent.

The dispenser body may then include a sleeve-like or cylindrical portion, between the first and second end portions. The water treatment substance may be in particulate form, eg may be of granular or tablet form, and may be contained within a first perforated bag located in the cylindrical portion. The water conditioning agent may also be in particulate form, eg may be in powdered, granular or kibbled form, and may be contained within a second perforated bag also located in the cylindrical portion, below the first perforated bag.

A single operatively downwardly directed primary aperture is provided at the first end of the dispenser body, with the dispenser including valve means for closing off the primary aperture when the dispenser is located at a first low level in a body of water, but allowing the primary aperture to be exposed or uncovered when the dispenser is at a second higher level in the body of water. The valve means comprises an externally located plug for closing off the primary aperture, a stem protruding from the plug through the primary aperture into the inside of the container body, and a retaining component protruding from the stem, for holding the plug and stem captive relative to the dispenser body.

In use, the dispenser will thus, when introduced into a body of water, sink to a first level, with water entering the body through the aperture and coming into contact with the water treatment substance, so that active ingredient is released by the water treatment substance into the water at the first level, and with the water treatment substance thus being consumed; after consumption of some of the water treatment substance, the dispenser then rises to a second higher level, ie to the surface of the water, at which active ingredient is dispensed for a further period of time. The water conditioning agent will also be dispensed at the second level, ie at the water surface.

The chemical dispenser may include a first outwardly rounded end piece closing off the first end of the cylindrical portion and in which the primary aperture is provided.

Instead of having a plurality of apertures, the dispenser body may have a plurality of aperture defining means, which are each capable of defining or providing an aperture. Each such aperture defining means may then comprise an external node or protuberance; on severing of the node or protuberance, an aperture (which provides access to the inside of the dispenser body) is thereby provided in the dispenser body.

The invention will now be described in more detail with reference to the accompanying diagrammatic drawings.

In the drawings,

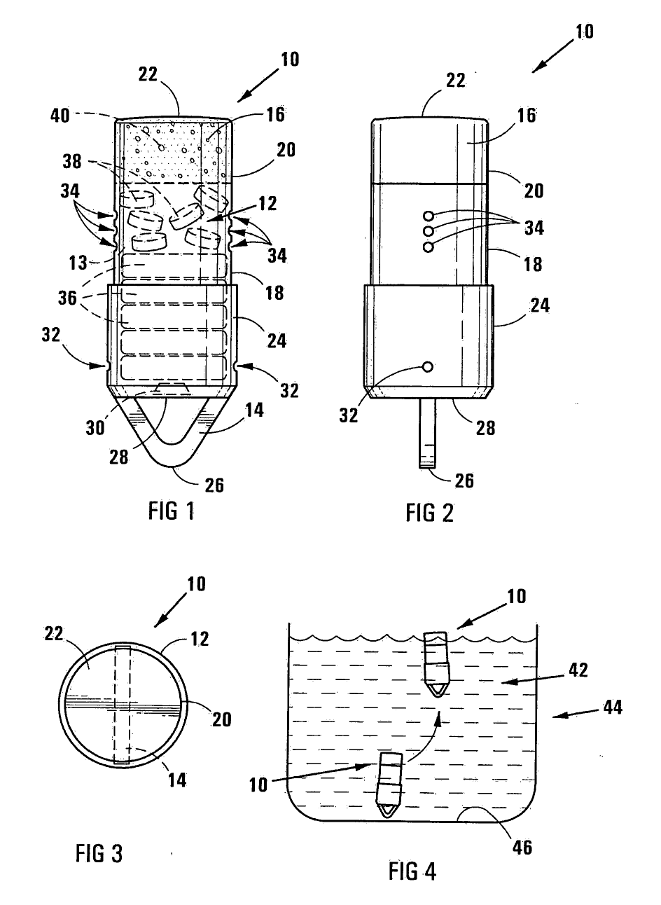

FIG. 1 shows a side view of a chemical dispenser, according to a first embodiment the invention, for dispensing an active ingredient into water;

FIG. 2 shows another side view (which is orientated 90° relative to the side view of FIG. 1) of the chemical dispenser of FIG. 1;

FIG. 3 shows a plan view of the chemical dispenser of FIG. 1;

FIG. 4 shows side views of the chemical dispenser of FIG. 1, in use, with the dispenser located at first and second levels respectively in a swimming pool;

FIG. 5 shows a side view of a chemical dispenser, according to a second embodiment of the invention, for dispensing an active ingredient into water;

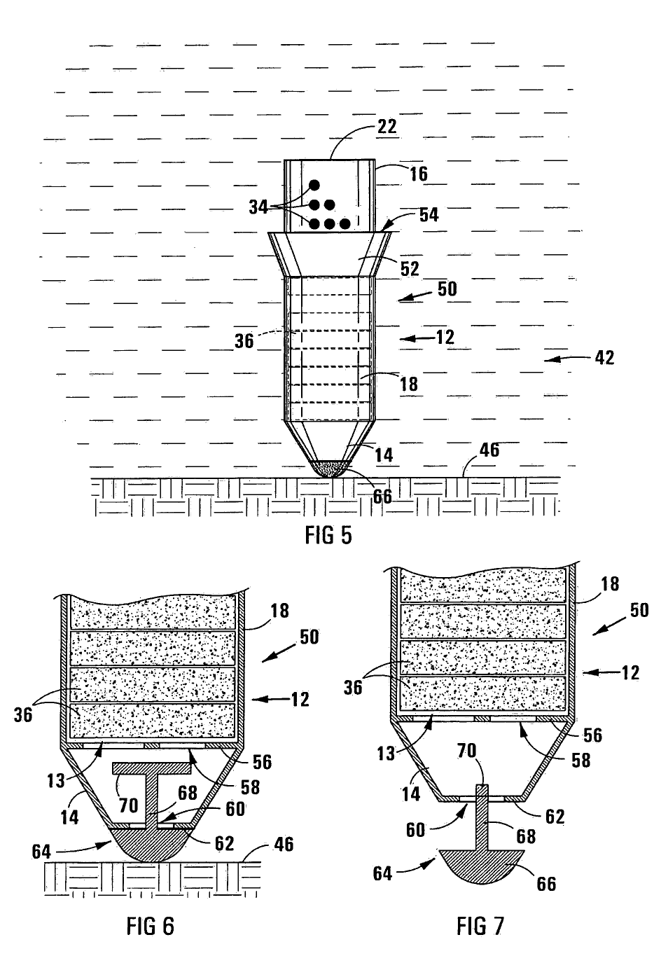

FIG. 6 shows an enlarge longitudinal sectional view of the dispenser of FIG. 5, located at a first level in a swimming pool;

FIG. 7 shows a longitudinal sectional view similar to that of FIG. 6, but with the dispenser orientated 90° relative to FIG. 6 and with the dispenser located at a second higher level in the swimming pool;

FIG. 8 shows a side view of a chemical dispenser, according to a third embodiment the invention, for dispensing an active ingredient into water;

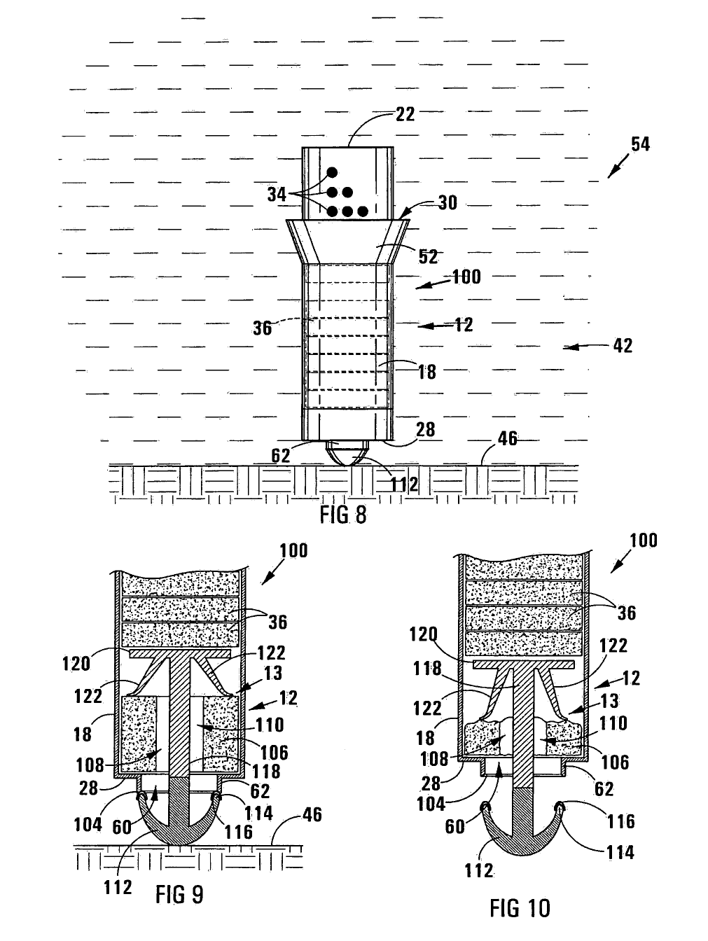

FIG. 9 shows an enlarged longitudinal sectional view of the chemical dispenser of FIG. 8, located at a first level in a swimming pool;

FIG. 10 shows a longitudinal sectional view similar to that of FIG. 9, but with the chemical dispenser located at a second higher level in the swimming pool;

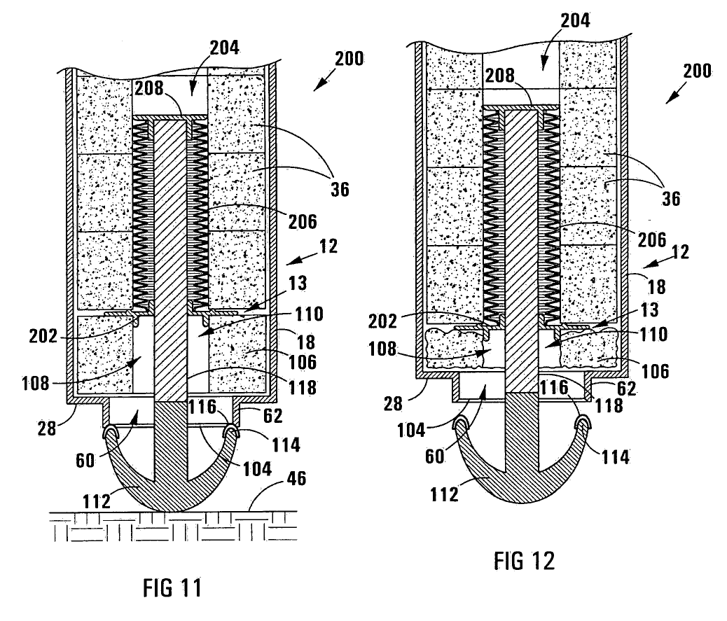

FIG. 11 shows an enlarged longitudinal sectional view of a chemical dispenser according to a fourth embodiment of the invention, for dispensing an active ingredient into water, located at a first level in a swimming pool;

FIG. 12 shows a longitudinal sectional view similar to that of FIG. 11, but with the dispenser located at a second higher level in the swimming pool;

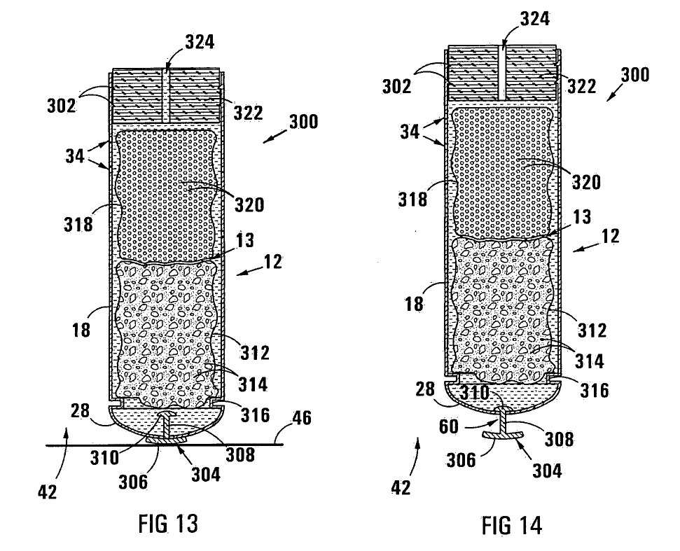

FIG. 13 shows a longitudinal sectional view of a chemical dispenser according to a fifth embodiment of the invention, with the chemical dispenser located at the bottom of a swimming pool;

FIG. 14 shows a similar longitudinal sectional view of the dispenser of FIG. 13, but with the chemical dispenser located at the surface of the water in the swimming pool;

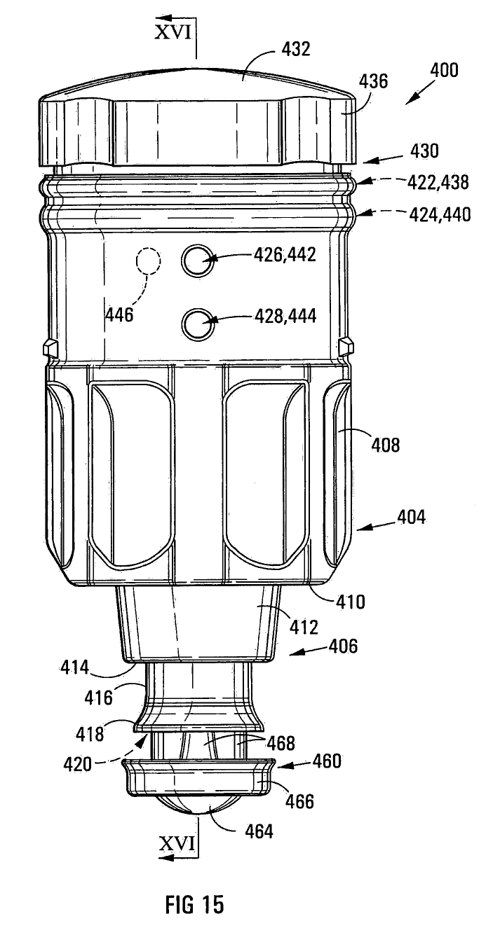

FIG. 15 shows a side view of a chemical dispenser according to a sixth embodiment of the invention, with its valve in an open position;

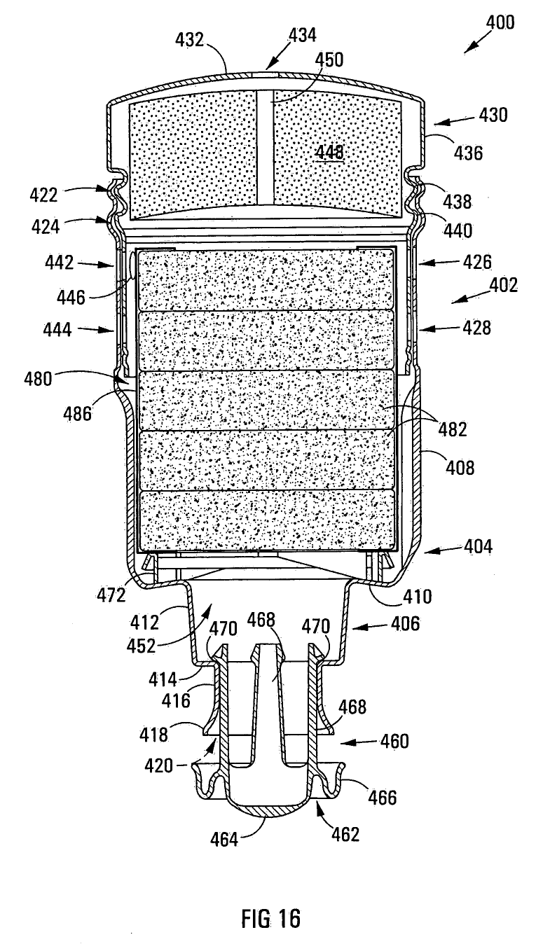

FIG. 16 shows a sectional view through XVI-XVI in FIG. 15;

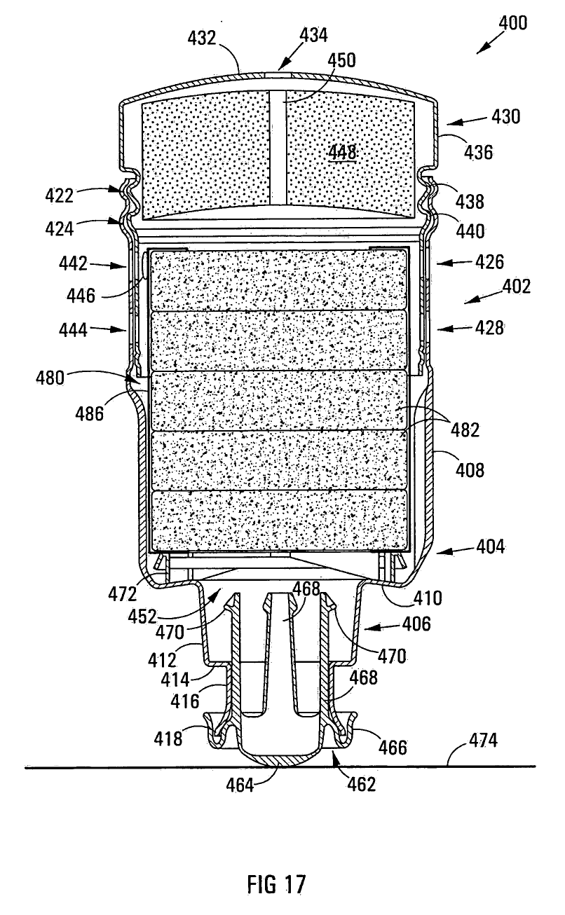

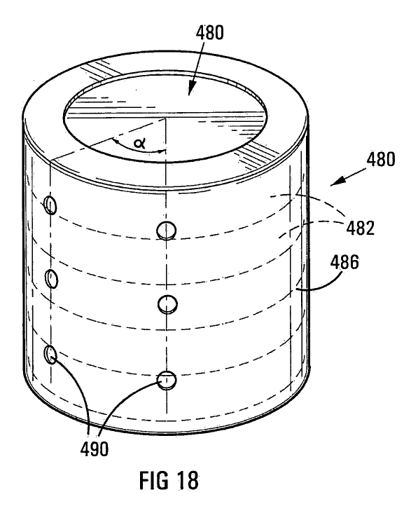

FIG. 17 shows a sectional view similar to FIG. 16 of the chemical dispenser of FIG. 15, but with the valve in a closed position;

FIG. 18 shows a three-dimensional view of the water treatment substance package of the dispenser of FIG. 15; and

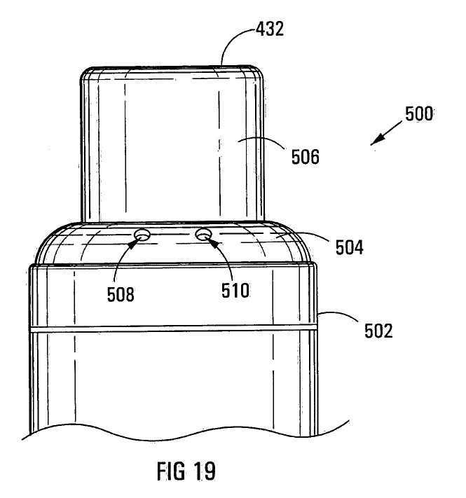

FIG. 19 shows a side view of an upper portion of a chemical dispenser according to a seventh embodiment of the invention.

In at least some of the drawings, the same or similar components are indicated with the same reference numerals.

Referring to FIGS. 1 to 4, reference numeral 10 generally indicates a chemical dispenser, according to a first embodiment of the invention, for dispensing an active ingredient into water.

The chemical dispenser 10 includes a hollow elongate buoyant dispenser body 12 providing an enclosed cavity 13. The dispenser body 12 includes a first end portion or piece 14 which, in use, is lowermost, as well as a second end portion 16 which is thus, in use, uppermost. A sleeve-like or cylindrical portion 18 is provided between the first and second end portions 14 and 16. The body 12 is circular in cross-section, as seen most clearly in FIG. 3.

The dispenser body 12 includes a cylindrical wall 20, the operatively upper end of which is closed off with an end piece or cap 22. The dispenser body 12 also includes a skirt component 24, from which protrudes the first end portion 14. The first end portion 14 tapers downwardly inwardly to a pointed end 26 which, in use, is lowermost. A flat portion or end piece 28 is provided between the skirt component 24 and the first end portion 14, and a raised nodule or platform 30 is provided on the flat portion 28, as indicated most clearly in FIG. 1.

The skirt component 24 fits snugly over the open end portion of the cylindrical wall 20 and is secured thereto.

A pair of diametrically opposed primary apertures 32 are provided in the skirt component 24, in proximity to the flat portion 28.

A plurality of diametrically opposed secondary apertures 34 are provided in the cylindrical wall 20, about half way between the open end of the cylindrical wall 20 and the end cap 22.

A breather hole (not shown) is provided in the end cap 22, so that air can escape from the body 12 when the dispenser is introduced into water.

Primary water treatment tablets 36 are located one above the other within the cylindrical portion 18, with the lowermost tablet 36 resting on the raised nodule or platform 30. The diameters of the primary tablets 36 are of the same order of magnitude as the diameter of the dispenser body 12, but with some clearance, eg a few millimeters, between the outer peripheries of the tablets and the cylindrical portion 18 of the dispenser body. Some of the primary tablets 36 comprise 96% (by mass) trichloroisocyanuric acid and 4% (by mass) aluminium sulphate as flocculant; the remainder of the primary tablets 36 consist of trichloroisocyanuric acid only.

Above the uppermost primary tablet 36, in proximity to the secondary apertures 34, are provided secondary water treatment tablets 38. The diameters of the secondary tablets 38 are substantially smaller than those of the primary tablets 36, and the secondary tablets 38 are randomly packed into the cylindrical portion 18. Voids 39, which are initially air-filled, are thus provided between adjacent secondary tablets 38.

The secondary tablets 38 consist of trichloroisocyanuric acid.

At the upper end of the cylindrical wall 20, ie against the end cap 22, is located foamed polystyrene 40 which, in use, imparts buoyancy to the dispenser 10.

The dispenser 10 is typically manufactured by first orientating the cylindrical wall 20 uprightly so that its open end is uppermost. The piece of foamed polystyrene 40 is then inserted into the cylindrical wall whereafter the required number of secondary tablets 38 are located randomly on top of the foamed polystyrene 40. Thereafter, the primary tablets 36 are located on top of the bed of secondary tablets 38. The skirt component 24 is then slidingly engaged over the open end of the cylindrical wall 20 until the raised nodule or platform 30 abuts against the uppermost primary tablet 36. The skirt component 24 is thereafter secured to the cylindrical wall 20, eg by welding.

Typically, the various components of the dispenser 10, apart from the piece of foamed polystyrene 40 and the tablets 36, 38, are of blow moulded plastics material.

It will further be appreciated that the primary apertures 32 as well as the secondary apertures 34 and the breather hole are initially closed off by means of external nodes or protuberances (not shown) which are integrally blow moulded with the skirt component 24 and the cylindrical wall 20 respectively. Prior to use, the nodes or protuberances defining or covering the primary apertures 32 and the breather hole are severed, eg by cutting them off with a knife, while the appropriate number of secondary apertures, depending on the size of the swimming pool to be treated, are similarly exposed or uncovered. Thus, the greater the swimming pool volume, the greater number of secondary apertures 34 that will be exposed by severing nodes or protuberances.

The first end portion 14 provides a convenient carry handle for carrying the dispenser 10 prior to, and after, use.

To use the dispenser 10, after the appropriate nodes or protuberances have been severed as hereinbefore described, the dispenser is placed in water 42 of a swimming pool 44 having a floor 46. The entire body 12 will fill with water, with the water displacing the air that is initially present in the body and the air escaping through the breather hole.

The number of primary tablets 36, ie the mass of primary tablets 36, the number of secondary tablets 38, ie the mass of secondary tablets 38, and the size of the foamed polystyrene 40, are selected such that the dispenser initially sinks to the bottom of the pool with its pointed end 26 resting on the pool floor. The dispenser is then located at a first level.

Water enters the apertures 32, 34, and circulates around the tablets 36, 38. The tablets 36, 38 slowly dissolve while releasing chlorine into the water. Chlorine-containing water and/or free chlorine, exits the dispenser through the openings 32, 34, thereby to dose the bulk body of water in the swimming pool 44 with chlorine.

The dispenser 10 thus initially has a negative buoyancy, which causes it to remain at the first level, ie at the bottom of the swimming pool. However, after several days, or possibly even after some weeks, sufficient of the tablets will have been consumed to impart a positive buoyancy to the dispenser. It then rises to a second level in proximity to the surface 48 of the water 42. The dispenser continues dosing chlorine into the water at this level, until the tablets have been exhausted. At that stage, the dispenser typically flips into a more-or-less horizontal position, indicating that dosing of the swimming pool water is no longer taking place.

The dispenser 10 is of elongate form and has a relatively high L:D (length to diameter) ratio. At all times, while dosing is taking place, it is in an upright vertical position. Its pointed end 26 is lowermost. This is the result of the dispenser buoyancy being concentrated at its operatively upper end, by virtue of the voids 39 between the secondary tablets 38, and the polystyrene body 40, while the density of the dispenser is concentrated at its operatively lower end, by virtue of the large and relatively heavy or dense primary tablets 36. In other words, the centre of gravity of the dispenser 10 is in proximity to its lower or first end portion 14.

The use of the smaller secondary tablets 28 in the space between the larger primary tablets 36 and the polystyrene body 40 results in the following advantages:
In use, water fills the voids or spaces between the secondary tablets 36, so that they are thus surrounded with water which has a lower density than the tablets, therefore enhancing the buoyancy of the dispenser 10.
The smaller secondary tablets 38 have a higher surface area to mass ratio than the primary tablets 36, which allows for an enhanced release of chlorine when the dispenser is located at the first level, ie at the bottom of the pool 44. The secondary tablets 38 thus ensure that a substantial amount of chlorine is released around the dispenser when it is at the bottom of the pool, with this relatively large amount of chlorine more easily being picked up and dispersed by water at the bottom of the swimming pool, which is normally slow circulating water. Thus, the mass ratio of larger primary tablets 36 to smaller secondary tablets 38 is largely determined by the need to provide the initial large amount of chlorine but this must be balanced by the buoyancy gradient required to maintain the dispenser in an upright position at all times.
The pointed or rounded end 26 ensures that the dispenser does not interfere with the performance of an automatic pool cleaner (not shown) that is used in the swimming pool. The pointed or rounded end 26 thus decreases the contact area between the dispenser and the floor of the pool, thereby lowering friction, and thus inertia, of the dispenser to the point that it will not affect the performance of an automatic pool cleaner, should the pool cleaner collide with it. The pool cleaner will thus easily push the dispenser away or simply pass underneath it, with the dispenser 10 again sinking to the bottom of the pool once the pool cleaner has passed underneath it. This in turn provides an additional benefit by causing increased water agitation inside the dispenser, which will result in the release of more chlorine, thereby assisting in chlorine dispersion at the bottom of the swimming pool. The pool cleaner will thereby also assist in moving the dispenser around the floor of the pool, thereby enhancing overall dispersion of chlorine into the swimming pool water.

It will be appreciated that the primary apertures 32 are located sufficiently far from the pointed end 26 of the dispenser so that there will be little or no risk of staining or bleaching of the swimming pool floor by virtue of chlorine-containing water passing from the apertures 32. In any event, it is believed that dispersion of chlorine into the swimming pool water will, when the dispenser is located in its lowermost position, be effected primarily through the secondary openings 34. However, once the dispenser has risen to its uppermost position in proximity to the surface of the water, the primary openings 32 then assist more strongly with dissolution of the primary tablets 36. The raised nodule or platform 30 then assists in dissolution of the lowermost primary tablet 36 since it permits water flow underneath the lowermost primary tablet 36.

It is envisaged that different sized dispensers 10, containing different quantities of primary and secondary tablets, will be provided for different sized pools. Typically, however, the mass of the dispenser will range between 1.2 kg and 2 kg. The primary tablets 36 can range in diameter from 65 mm to 80 mm, and weigh from 150 g to 250 g each. The secondary tablets 38 can range in mass from 10 g to 40 g.

In another embodiment of the invention (not shown), instead of the apertures 32, 34 being exposed or defined by cutting off nodules, the lengths of the cylindrical wall 20 and the skirt component 24 can be such that they overlap in the region of the apertures 32, 34. Complementary apertures will then be provided in the cylindrical wall 20 and the skirt portion 24, with the cylindrical wall and skirt component then being rotated until the apertures in the skirt component 24 are in register with those in the cylindrical wall 20, thereby exposing the inside of the dispenser body to the water in the swimming pool.

By virtue of the buoyancy of the dispenser 10 which ensures that it is orientated in a vertical configuration at all times, the dispenser will naturally return to its vertical position if it is disturbed or struck by a swimmer. This may cause the dispenser to fall over, but it will immediately return to its vertical position. This will ensure that high localized concentrations of chlorine on the pool surfaces, which could arise if the dispenser were to remain lying on the swimming pool floor for some time, are avoided.

Referring to FIGS. 5 to 7, reference numeral 50 generally indicates a chemical dispenser according to a second embodiment of the invention, for dispensing an active ingredient into water.

The chemical dispenser 50 also has a plurality of the secondary apertures 34; however, in the case of the dispenser 50, the apertures 34 are located closer to the upper end piece 22.

The dispenser 50 includes an upwardly outwardly flaring skirt 52, located around the dispenser body 12, immediately below the secondary apertures 34. A zone 54 is thus defined between the skirt 52 and the dispenser body 12.

The dispenser 50 includes, at the lower end of the dispenser body 12, a cross-shaped tablet support 56 on which the lowermost tablet 36 rests. Because of the cross-shape of the support 56, it thus has openings, generally indicated by reference numeral 58, through which water can pass from the dispenser body cavity 13 into the first end portion 14 and vice versa.

The first end portion 14 of the dispenser 50 is thus hollow and its apex or tip is flattened, as seen most clearly in FIGS. 6 and 7. A single primary aperture 60 is provided in the flattened portion of the end portion 14, with a flange or rim 62 being defined around the aperture 60.

The dispenser 50 also includes valve means, generally indicated by reference numeral 64, for closing off the primary aperture 60.

The valve means 64 includes an inverted mushroom-shaped plug 66, a stem 68 protruding from the flattened portion of the plug 66 through the primary aperture 60 into the inside of the first end portion 14, and an elongate retaining component 70 at the free end of the stem 68. The length of the retaining component 70 is such that it cannot pass through the aperture 60 but can abut the flange 62. The plug 66 is typically of a more dense, ie heavier, plastic material than the dispenser body 12, and also has a higher density than water.

In use, any chlorine-containing water that passes outwardly through the apertures 34, can be caught in the zone 54, before passing into the bulk body of water 42.

When the dispenser 50 is located at the first level in which it abuts the swimming pool floor 46, the rounded portion of the plug 66 abuts against the floor 46, and its flattened portion is urged into contact with the flange 66 as shown in FIG. 6. In this fashion, the primary aperture 60 is closed off. However, when the dispenser 50 rises to the second level, the heavier plug 66 moves downwardly relative to the dispenser body 12, until its retaining component 70 engages the rim 62 of the inside of the end portion 14. In this fashion, the primary aperture is uncovered, thereby permitting water also to enter and exit the inside of the dispenser body 18 through the primary aperture 60.

It is envisaged that the dispenser 50 (and the dispensers 100 and 200 hereinafter described) will be used primarily (but not necessarily exclusively) to dose water in swimming pools where there is a risk of bleaching of coloured swimming pool surfaces when the dispenser is located at the first level in which its lower end abuts the swimming pool floor 46. Such bleaching can arise in cases where the swimming pool water is stationary, ie where a swimming pool water filtration pump is not running. The tablets 36 naturally keep dissolving, and since the chlorinated water solution thus produced is heavier than the bulk water 42 it can, in the case of the dispenser 10, pass through its primary apertures 32 and concentrate on the floor 46 immediately below and around the lower end of the dispenser 10. This build-up of chlorine concentrate on the floor 46 can lead to bleaching of coloured full surfaces such as Marbelite™ surfaces.

Such a potential problem is addressed with the dispenser 50 (and with the dispensers 100 and 200 hereinafter described). In the dispenser 50, the secondary apertures 34 are located further from the swimming pool floor 46 (when the dispenser is at the first level) since they are located closer to the upper end piece 22 of the dispenser body 12. Additionally, when the dispenser 50 is located at the first level its primary aperture 60 will be closed off as hereinbefore described. It is believed that these measures will aid in providing adequate dispersion of any concentrated chlorine solution that is formed when the pool pump is not running since such concentrated solution can only be dispensed by the dispenser 50 through the apertures 34 which are thus located further from the floor 46 than in the case of the dispenser 10. This effect is further enhanced by the zone 54 provided by the skirt 52, which is typically of injection-moulded plastic and which typically clips around the dispenser body 12. The zone 54 thus acts as a catchment zone for heavier chlorinated solution at times when the pool pump is not running. When the pool pump restarts, the bulk water in the pool will start to circulate (or an automatic pool cleaner can possibly bump against the dispenser 50), with any concentrated chlorine solution that has collected in the zone 54 then slowly dispersing from the zone 54 into the bulk pool water.

When the dispenser 50 rises to the second level the primary aperture 60 is uncovered as hereinbefore described. This will permit water flow around the lower most tablets 36, causing them to dissolve while the dispenser is at the second level. This will assist in maintaining chlorine dosage levels once the dispenser 50 has risen to the second level.

It will be appreciated that, as a result of the plug 66 closing off the primary aperture 60 when the dispenser is located at the first level, substantially no chlorine, or at least insufficient chlorine to stain the floor 46, will pass through the primary aperture 60 when the dispenser 50 is at the first level.

Referring to FIGS. 8 to 10, reference numeral 100 generally indicates a chemical dispenser according to a third embodiment of the invention, for dispensing an active ingredient into water.

The primary aperture 60 of the dispenser 100 is defined by an outwardly protruding rim or shoulder 62 having a beveled inner edge or rim portion 104 defining a circular seat.

An elongate primary water treatment tablet 106 is provided, with the tablet 3106 resting on the end piece 14. The tablet 106 has a central passageway 108.

The dispenser 100 also includes closure or valve means, generally indicated by reference numeral 110. The valve means 110 includes a cup-shaped external closure member 112 having a peripheral edge portion 114. A seal ring 116, of rubber-like material, fits over the edge portion 114, and ensures that the closure member 112 can seal water tightly against the seat defined by the beveled portion 104 of the rim 62 protruding from the end piece 28, as shown most clearly in FIG. 9. The closure member 112 is typically of a more dense, ie heavier, plastic material than the dispenser body 12, and also has a higher density than water.

The valve means 110 also includes a stem 118 protruding from the inside of the closure member 112 through the primary aperture 60 and through the central passageway 108 of the tablet 106, with a retaining member 120 in the form of a disc being provided at the free or distal end of the stem 118.

Bias means in the form of a plurality of resiliently flexible limbs 122 protrude from the retaining member 120 in the direction of the closure member 112. The limbs 122 will normally be in the position indicated in FIG. 10, ie in which they are more-or-less parallel to the stem 118. However, initially, ie when the tablet 106 has not yet been consumed, the limbs 122 are in the position indicated in FIG. 9 in which they have been biased towards the retaining member 120. The bias exerted by the limbs 122, when in this position, urges the tablet 106 against the end piece 14, and also urges the seal ring 116 firmly into engagement with the seat defined by the beveled rim portion 104, thereby sealing off the primary aperture 20.

A plurality of circular primary water treatment tablets 36 are located one above the other within the cavity 13, on top of the retaining member 120. The limbs 122 are resilient enough to overcome the weight exerted on the retaining member 120 by the primary tablets 36 and still to urge the seal ring 116 to seal off the primary aperture 20.

In another embodiment (not shown), the primary tablets 36 are slightly wider such that the primary tablets 36 at least partially frictionally engage the dispenser body 12 thereby to reduce the weight which the primary tablets 36 exert on the retaining member 120. Instead, or in addition, fewer primary tablets 36 can be located above the retaining member 120 to reduce the weight which the primary tablets 36 exert on the retaining member 120.

The primary tablet 106 also comprises 90% (by mass) trichloroisocyanuric acid and 10% (by mass) aluminium sulphide and sodium chloride.

To use the dispenser 100, after the appropriate nodes or protuberances have been severed as hereinbefore described, the dispenser is placed in water 42 of the swimming pool 44. The entire body 12 will fill with water, with the water displacing the air that is initially present in the body and the air escaping through a breather hole (not shown) in the upper end piece 22.

The number of primary tablets 36, 106, ie the mass of primary tablets 36, 106, the number of secondary tablets, ie the mass of secondary tablets, and the size of the foamed polystyrene, are selected such that the dispenser initially sinks to the bottom of the pool with its closure member 112 resting on the pool floor. The dispenser is then located at a first level.

Water enters the secondary apertures and circulates around the primary and secondary tablets. The tablets slowly dissolve while releasing chlorine into the water. Chlorine-containing water and/or free chlorine, exits the dispenser through the secondary openings, thereby to dose the bulk body of water in the swimming pool 44 with chlorine.

When the dispenser 100 is located at the first level in which it abuts the swimming pool floor 46, the rounded portion of the closure member 112 abuts against the floor 46, and its edge portion 114 (and seal ring 116) is urged into contact with the flange 62 as shown in FIG. 9. This assists the limbs 122 in keeping the closure member 112 firmly in position.

The dispenser 100 thus initially has a negative buoyancy, which causes it to remain at the first level, ie at the bottom of the swimming pool. However, after several days, or possibly even after some weeks, sufficient of the tablets will have been consumed to impart a positive buoyancy to the dispenser. It then rises to a second level (not shown) in proximity to the surface of the water 42. The dispenser continues dosing chlorine into the water at this level, until the tablets have been exhausted.

When the dispenser 100 has risen to the second level, the valve means 110 will normally still be in the position indicated in FIG. 9. However, as the primary tablet 106 is consumed, its length will decrease thereby causing the limbs 122 to be biased into the position indicated in FIG. 10. As the tablet 106 is consumed even further, its length will shorten still further causing the stem 118 and the closure member 112 to move downwardly, assisted by the mass of the tablets 36 resting on the retaining member 120. The closure member 112 will then unseat from the rim 62, causing the primary aperture 60 to be exposed. The negative buoyancy, that is heavier than water density, of the closure member 112 assists in causing it to unseat from the rim 62. Once the primary aperture 60 has been exposed, water can also enter and exit the dispenser body 12 through the primary aperture 60.

Once all the tablets have been exhausted the dispenser 100 typically flips into a more-or-less horizontal position while floating on the surface of the water, thereby indicating that dosing of swimming pool water is no longer taking place.

Referring to FIGS. 11 and 12, reference numeral 200 generally indicates a chemical dispenser according to a fourth embodiment of the invention, for dispensing an active ingredient into water.

The closure or valve means 110 of the dispenser 200 included a spring bearing member 202 located with sliding clearance around the stem 118 and abutting the upper surface of the tablet 106. The spring bearing member 202 is thus not fixed to the stem 118, and can move in an axial direction relative to the stem. A plurality of circular primary water treatment tablets 36 having central openings 204, are located one above the other within the cavity 13, on top of the spring bearing member 202. The stem 118 protrudes through the central openings 204 of the lowermost primary tablets 36, as shown most clearly in FIGS. 12 and 13. A concertina-type spring 206 is provided around the stem 118 and is sandwiched between the spring bearing member 202 and a cap 208 fitted to the upper end of the stem 118. The spring 206 is under compression, and thus serves to urge the seal ring 116 of the closure member 112 firmly into engagement with rim 62, at least initially when the tablets 106, 36 have not yet been consumed. In this regard, see in particular FIG. 12.

To use the dispenser 200, after the appropriate nodes or protuberances have been severed as hereinbefore described, the dispenser is placed in water 42 of the swimming pool 44. The entire body 12 will fill with water, with the water displacing the air that is initially present in the body and the air escaping through breather hole (not shown) in the upper end piece 22.

The number of primary tablets 36, 106, ie the mass of primary tablets 36, 106, the number of secondary tablets, ie the mass of secondary tablets, and the size of the foamed polystyrene, are selected such that the dispenser initially sinks to the bottom of the pool with its closure member 112 resting on the pool floor. The dispenser is then located at a first level.

Water enters the secondary apertures and circulates around the primary and secondary tablets. The tablets slowly dissolve while releasing chlorine into the water. Chlorine-containing water and/or free chlorine, exits the dispenser through the secondary openings, thereby to dose the bulk body of water in the swimming pool 44 with chlorine.

When the dispenser 200 is located at the first level in which it abuts the swimming pool floor 46, the rounded portion of the closure member 112 abuts against the floor 46, and its edge portion 114 (and the seal ring 132) is urged into contact with the flange 62 as shown in FIG. 12. This assists the spring 206 in keeping the closure member 128 firmly in position.

The dispenser 200 thus initially has a negative buoyancy, which causes it to remain at the first level, ie at the bottom of the swimming pool. However, after several days, or possibly even after some weeks, sufficient of the tablets will have been consumed to impart a positive buoyancy to the dispenser. It then rises to a second level (not shown) in proximity to the surface of the water 42. The dispenser continues dosing chlorine into the water at this level, until the tablets have been exhausted.

When the dispenser 200 has risen to the second level, the valve means 110 will normally still be in the position indicated in FIG. 12. However, as the primary tablet 106 is consumed, its thickness will decrease. As its thickness decreases, the spring 206 extends until it is no longer under compression. This will cause the stem 118 and the closure member 112 to move downwardly, due to the negative buoyancy, that is heavier than water density, of the closure member 112. The closure member 112 will then unseat from the rim 102, causing the primary aperture 20 to be exposed. Once the primary aperture 20 has been exposed, water can also enter and exit the dispenser body 12 through the primary aperture 20.

Once all the tablets have been exhausted, the dispenser 200 typically flips into a more-or-less horizontal position while floating on the surface of the water, thereby indicating that dosing of swimming pool water is no longer taking place.

The Applicant believes that use of the dispensers 10, 50, 100 and 200 gives rise to a number of significant advantages as compared to existing means of dosing swimming pools with chlorine, such as surface floating chlorine dispensers:
A significant percentage of chlorine dosing to swimming pools is lost due to the action of the sun. It is therefore advantageous to dispense chlorine away from the water surface, where the solar interaction takes place. This is achieved with the dispensers 10, 50, 100 and 200 which, for a substantial period of time, dispense chlorine at the bottom of the pool where there is substantially less solar interaction.
Most swimming pools are designed with their water pump withdrawal and return apertures at the water surface, with the result that distribution of treatment chemicals such as chlorine, to the deepest part of the pool, being inhibited. This drawback is overcome or at least reduced with the dispensers 10, 50, 100 and 200.
Surface floating chlorine dispensers are considered unsightly by many pool owners. This drawback is overcome, or at least reduced, with the dispensers 10, 50, 100 and 200 since they are submerged for a large portion of its operational time.
On the other hand, in-line chlorine dispensers that are located in the pump return line to the pool, while avoiding the problem of unsightliness, are not as convenient to use as floating dispensers. Thus, again, the dispensers 10, 50, 100 and 200 overcome this problem.
Very high localized concentrations of chlorine can cause staining or bleaching of pool surfaces. Chlorine should thus be released as far from pool surfaces as possible. With the dispensers 10, 50, 100 and 200, the dispensing apertures 32, 34 are located a sufficient distance from the pool floor 46 so that staining or bleaching thereof will not readily occur.
While the dispensers 10, 50, 100 and 200 are initially negatively buoyant so that they remain at the bottom of the pool, they eventually surface to the surface of the water, thereby overcoming the inconvenience of having manually to retrieve a depleted dispenser from the bottom of the pool.
Since the partially depleted dispensers rise to the water surface, this provides a ready indication to user that the dispensers are reaching the end of their useful dispensing lifetimes.
It is essential that all areas or zones in a pool be sanitized or dosed. As hereinbefore described, although the dispensers 10, 50, 100 and 200 dose chlorine at the bottom of the pool, due to the increased concentrations of chlorine that are released by the secondary tablets 38 at the initial low level as well as the movement that is imparted to the dispensers 10, 50, 100 and 200 by an automatic pool cleaning device, satisfactory chlorine dosage throughout the pool is achieved.
As hereinbefore set out, the dispensers 10, 50, 100 and 200 will not readily interfere with the movement and action of an automatic pool cleaner by virtue of the relatively small area of contact of their lower ends with the swimming pool floor 46. This is in spite of the dispensers being relatively heavy and inert, due to the number of primary and secondary tablets that they must contain in order for them to be effective in a medium to large swimming pool.
The amount of chlorine released by given mass of tablets reduces as the surface area of the tablets decreases through depletion of the tablets. This will result in adequate release when the dispensers are first placed in the pool, but under chlorination as the mass, and therefore the surface area, of the tablets reduce. This problem is avoided or at least reduced with the dispensers 10, 50, 100 and 200 which, once the tablets are partially depleted, rise to the surface of the pool where there is enhanced water circulation and hence enhanced chlorine dosage, as compared to the bottom of the pool.

The dispensers 10, 50, 100 and 200 thus present a compromise between the desirability of dispensing chlorine deep inside a swimming pool and the difficulty of maintaining adequate chlorination throughout the life of the dispenser, while still maintaining acceptable levels of convenience for the user. Thus, the dispensers 10, 50, 100 and 200 release only part of their chlorine near the floor of the pool, before surfacing and releasing the remainder near the surface as is the case with known surface floating dispensers.

Referring to FIGS. 13 and 14, reference numeral 300 generally indicates a chemical dispenser according to a fifth embodiment of the invention.

The operatively upper end of the cylindrical portion 18 of the chemical dispenser 300 is open, and is provided with internally protruding circumferentially extending retaining ridges 302.

The primary aperture 60 is fitted with valve means, generally indicated by reference numeral 304. The valve means 304 includes a rounded plug or closure member 306 having the same radius of curvature as the rounded end portion 28 so that it can close off the primary aperture 60. A stem 308 protrudes from the closure member 306 through the primary aperture 60 and is provided with a transversely extending elongate retaining member 310. The valve means 304 is of relatively dense plastics material, ie plastics material whose density is greater than that of water.

A perforated bag 312, containing particulate aluminium sulphate 314, is located inside the cavity 13, at the operatively lower end of the dispenser 300. The bag 312 rests on an inwardly protruding circumferentially extending shoulder 316 provided at the junction of the cylindrical portion 18 with the end portion 28. Thus, the bag 32 cannot interfere with the operation of the valve 304. The aluminium sulphate is in kibbled form, ie in the form of large particles up to 25 mm in size.

The perforated bag or pouch 312 assists in retarding dissolution of the aluminium sulphate (alum) which is beneficial for two reasons: Dissolution of aluminium sulphate is thereby retarded until the dispenser has reached the water surface, and in addition aluminium sulphate, which is an acid, is thereby prevented from dissolving near the floor of the pool in sufficiently large quantities to stain the pool floor.

Above the bag 312 is located a second perforated bag 318, containing granular calcium hypochlorite 320. The perforated bag or pouch 318 serves to prevent the calcium hypochlorite granules 320 from spilling out of the dispenser 300 before it is placed in the pool.

The secondary apertures 34 in the cylindrical portion 18 are located in proximity to the bag 320.

At the operatively upper end of the cylindrical portion 18 is provided a polystyrene plug 322 which has a central passageway 324. The polystyrene plug 322 serves to impart buoyancy to the dispenser 300, and is retained in position by the retaining ridges or formations 302.

In use, when it is desired to subject swimming pool water to shock treatment, eg as a result of heavy bather loads or due to rain, the chemical dispenser 300 is introduced into the swimming pool water 42. The dispenser 300 initially contains sufficient calcium hypochlorite 320 and aluminium sulphate 314 so that it sinks to the bottom of the swimming pool where it rests on the swimming pool floor 46, as shown in FIG. 13. Due to the weight of the dispenser, the valve 304 is forced into or retained in its shut position. The dispenser 300 is orientated vertically when it is at the bottom of the swimming pool, as also shown in FIG. 13.

Water enters the secondary apertures 34 where it dissolves the calcium hypochlorite (which is a rapidly dissolving chlorine containing compound) so that chlorine is released into the water. The chlorine containing water also passes through the apertures 34, thereby to treat or dose the bulk swimming pool water at the bottom of the swimming pool.

When some of the calcium hypochlorite has been dissolved, the buoyancy imparted by the polystyrene plug 322 will cause the dispenser to rise to the surface of the water, whilst still orientated vertically, as shown in FIG. 14. At the surface of the water, calcium hypochlorite will continue to be dissolved and dispensed, thereby also to treat swimming pool water at proximity to the surface of the pool.

As the dispenser 300 rises to the second level, the valve means 304 will unseat or open due to the fact that the components of the valve means 304 are of a material which is more dense than water, as shown in FIG. 13. Thus, water can also, when the dispenser 300 is at the second or surface level, enter the cavity 34 through the primary aperture 60. While the dispenser is at the second level, aluminium sulphate will thus also dissolve in water entering the cavity 13, and will be dispensed into the bulk body of water, primarily through the primary aperture 60.

The diameter of the cylindrical portion or wall 18 will be relatively small as compared to its length, so as to assist in the vertical orientation of the dispenser 300 when at the different levels.

When all the calcium hypochlorite and aluminium sulphate have been consumed, the dispenser 300 will flip over onto its side and float in the water (not shown), thereby indicating to a user that shock treatment has been completed. The empty dispenser can then be removed.

The central passageway 324 in the polystyrene plug 322 allows air to escape from the cavity 13 once the dispenser 300 has been introduced into the water. It will be appreciated that the purpose of the polystyrene plug 322 is to provide sufficient buoyancy to the dispenser so that it will assume an upright configuration in the water while the chemicals are being dispensed. The polystyrene plug will also be sized so that it will cause the dispenser 300 to rise to the surface of the water once a predetermined quantity of the calcium hypochlorite has been consumed.

Typically, the dispenser 300 will initially contain between 350 g and 500 g of aluminium sulphate kibbles in the perforated bag 312, and 500 g to 600 g of calcium hypochlorite in the perforated bag 318. The polystyrene plug 322 can then be sized so that the dispenser 300 will rise from the bottom of the pool to the pool surface when between 100 g-250 g of calcium hypochlorite have been consumed. Typically, the dispenser 300 will remain at the bottom of the pool for 1-2 hours, and will continue to dispense chlorine, when at the pool surface, for another 1-2 hours so that all calcium hypochlorite is consumed within 3-4 hours of the dispenser 300 having been introduced into the water. The aluminium sulphate will typically be consumed within 7-12 hours.

As indicated hereinbefore, swimming pools require extra doses of chlorine from time to time, eg to kill off algal growth, to compensate for increases in chlorine demand due to rain, bather loads, etc, and to oxidize organic waste. Presently, such shock treatment is effected by a pool user sprinkling granular calcium hypochlorite on the surface of the water. However, such shock dosing is not particularly effective since insufficient chlorine makes its way to the deepest parts of the swimming pool. Very high chlorine concentrations near the surface of the water also allow chlorine to disperse readily to the atmosphere, which is wasteful.

Furthermore, once shock treatment has taken place, the products of oxidation achieved by means of the chlorination, eg dead algal cells or complex chemical matter, needs to be filtered out. This filtration is normally effected by merely allowing the swimming pool pump and filter to operate as normal which is not particularly efficient as regards removing the additional products of oxidation that are formed.

With the dispenser 300, these problems are addressed. Firstly, due to the fact that the dispenser initially sinks to the bottom of the pool, the water at the deepest part of the pool is also shock treated with chlorine. The dispensing of the aluminium sulphate, which is a flocculating agent/filtration agent, will thereafter assist in achieving efficient removal of the products of oxidation. The aluminium sulphate thus assists in clarifying the pool water once it has been shock-dosed with chlorine.

Referring to FIGS. 15 to 18, reference numeral 400 generally indicates a chemical dispenser according to a sixth embodiment of the invention. The dispenser 400 includes a hollow elongate buoyant dispenser body which is, in use, generally uprightly orientated as shown in the drawings, and which is generally represented by reference numeral 402.

The body 402 includes a first component, generally indicated by reference numeral 404. The first component 404 comprises an annular end piece, generally indicated by reference numeral 406, and a cylindrical circular-section wall portion 408.

The annular end piece 406 includes a first annular member 410, with the wall portion 408 protruding upwardly from the outer peripheral edge of the first annular member 410. A first cylindrical portion 412 protrudes downwardly from the inner peripheral edge of the first annular member 410. A second annular member 414 extends inwardly from the free or lowermost end of the first cylindrical portion 412. A second cylindrical portion 416 protrudes downwardly from the inner peripheral edge of the second annular member 414. A lower end portion 418 of the second annular member 416 flares outwardly, and defines a circular downwardly directed primary aperture 420.

Towards its upper end, the wall portion 408 is provided with peripherally extending grooves 422, 424. Immediately below the grooves 422, 424, there are provided two groups of secondary apertures or openings in the wall portion 408. The groups of openings are spaced diametrically apart. Each group comprises an upper opening, generally indicated by reference numeral 426, and a lower opening, generally indicated by reference numeral 428. The diameters of the openings 426, 428 are typically about 10 mm.

The body 402 also includes a second component, generally indicated by reference numeral 430. The second component 430 comprises an arcuate end cap 432 provided with a central bleed aperture 434, as well as a cylindrical circular-section wall portion 436 protruding downwardly from the end cap 432. The wall portion 436 is provided with two longitudinally spaced circumferentially extending ridges 438, 440 which are respectively accommodated in the grooves 422, 424 of the wall portion 408 of the first component 404. The ridges 438, 440 and grooves 422, 424 thus prevent the first component 404 and the second component 430 from separating in an axial direction, while permitting relative rotation thereof.

Below the ridges 438, 440, the wall portion 436 is also provided with two groups of secondary apertures or openings. Each group of openings comprises an upper opening, generally indicated by reference numeral 442 and a lower opening generally indicated by reference numeral 444. A further opening 446, which is at the same level as the opening 442, is also provided in each group of openings, with the opening 446 being spaced peripherally from the opening 442. The diameters of the openings 442, 444 and 446 are typically about 8 mm.

The openings 442, 446 are at the same level as the openings 426 in the wall portion 408, while the openings 444 are at the same level as the openings 428 in the wall portion 408. Thus, by rotating the first component 404 relative to the second component 430, either the openings 442, 444 can be brought into register with the openings 426, 428, or only the openings 426 can be brought into register with the opening 446, with the openings 428 then effectively being closed off. In this fashion, the rate of dosage of water treatment substance from the dispenser 400 can be regulated.

A block of buoyant polystyrene 448, provided with a central bleed passageway 450 which is aligned with the opening 434 in the end cap 432, is located within the second component 430, adjacent the end cap 432.

The first component 404 and second component 430 define an enclosed cavity, generally indicated by reference numeral 452.

The dispenser 400 also includes valve means, generally indicated by reference numeral 460, for closing off the primary aperture 420. The valve means 460 comprises a valve cap, generally indicated by reference numeral 462. The valve cap comprises a cup-shaped central component 464 with an annular recessed component 466 extending around the central component 464. The annular component 466 is dimensioned to receive the lower end portion 418 of the second cylindrical portion 416 thereby closing off the primary aperture 420, as indicated in FIG. 17.

Four prongs 468 protrude upwardly from the valve cap 462 and pass through the second cylindrical portion 416 with sliding clearance. The upper free ends of the prongs 468 are provided with engagement or retaining formations 470 which prevent detachment of the valve means 460 from the dispenser body 402, when the valve is in its open position, as indicated in FIGS. 15 and 16.

A spacer 472 protrudes upwardly from the first annular component 410.

The dispenser 400 also includes a water treatment substance package, generally indicated by reference numeral 480, located within the cavity 452 and resting on the spacer 472.

The water treatment substance package 480 includes five circular tablets 482 located one above the other and encased by a water impervious PVC sleeve or wrapper 486 shrink-wrapped over the tablets so that axial openings 488 are provided at either end of the package. A plurality of openings 490 are provided in the wall of the sleeve 486. The openings 490 are arranged in two rows of three openings each, and the rows are spaced apart at an angle α where α is from 20° to 50°. Typically, the package 480 comprises five tablets of about 150 g each.

In one embodiment of the invention, the tablets may comprise calcium hypochlorite, chloride of lime and zinc stearate, and may hence have a composition as described in ZA 77/00938.

However, in another embodiment of the invention, the tablets may comprise calcium hypochlorite, sodium chloride and zinc stearate. For summer use, ie for use in warmer water, the tablet composition may comprise, by mass, 93% to 96% calcium hypochlorite, 3% to 5% sodium chloride, and 1% to 2% zinc stearate. For winter use, ie for use in colder water, the tablet composition may then comprise, by mass, 91% to 94% sodium hypochlorite, 5% to 7% sodium chloride, and 1% to 2% zinc stearate.

In use, the dispenser 400 is placed in a swimming pool whose water is to be dosed in chlorine. The entire body 402 fills with water which enters through the secondary apertures 426, 442 (or 446) and 428, 444. The water thus displaces the air that is initially present in the body with the air primarily escaping through the polystyrene block passageway 450 and the opening 434. The mass of the tablets 482 is sufficient for the dispenser to sink to the floor 474 of the pool, ie the dispenser is then at a first lower level with chlorine dosage being effected through the secondary apertures 426, 442 (or 446) and 428, 444.

When the valve 460 rests on the pool floor, the lower end 418 of the cylindrical portion 416 will be located in the valve cap recess 466, thereby closing off the primary aperture 420. In other words, there will be no dispensing of chlorine containing water through the primary aperture 420 while the dispenser is located on the pool floor. The dispenser 400 thus initially has a negative buoyancy, which causes it to remain at the first level, ie at the bottom of the swimming pool. However, after several days, or possibly even after some weeks, sufficient of the tablets will have been consumed to impart a positive buoyancy to the dispenser. It then rises to a second level in proximity to the surface of the water.

At this second level, it continues to dispense chlorine containing water through the secondary apertures 426, 442 and 428, 444; however, since the valve cap 462 drops relative to the body 402, under the influence of gravity, to the position indicated in FIGS. 15 and 16 in which the primary aperture 420 is exposed, dispensing of chlorine containing water through the primary aperture 420 will also take place when the dispenser is at the surface of the water, ie at its second level.

The rounded form of the valve cap 462 ensures that the dispenser does not interfere with the performance of an automatic pool cleaner (not shown) that is used in the swimming pool. The rounded lower end of the valve cap 462 decreases the contact area between the dispenser and the floor of the pool, thereby lowering friction, and thus inertia of the dispenser to the point that it will not affect the performance of an automatic pool cleaner should the pool cleaner collide with it. The pool cleaner will thus easily push the dispenser away or simply pass underneath it, with the dispenser 400 again sinking to the bottom of the pool once the pool cleaner has passed underneath it. This in turn provides an additional benefit by causing increased water agitation inside the dispenser, which will result in the release of more chlorine, thereby assisting in chlorine dispersion at the bottom of the swimming pool. The pool cleaner will thereby also assist in moving the dispenser around the floor of the pool, thereby enhancing overall dispersion of chlorine into the swimming pool water. It will, however, be appreciated that the apertures 426, 442 and 428, 444 are located sufficiently far from the lower end of the dispenser so that there will be little or no risk of staining or bleaching of the swimming pool floor by virtue of chlorine containing water passing through these apertures.

It is envisaged that the dispenser 400 will be used primarily (but not necessarily exclusively) to dose water in swimming pools where there is a risk of bleaching of coloured swimming pool surfaces when the dispenser is located at the first level in which its lower end abuts the swimming pool floor. Such bleaching can arise in cases where the swimming pool water is stationary, ie where a swimming pool water filtration pump is not running. The tablets 482 naturally keep dissolving, and since the chlorinated water solution thus produced is heavier than the bulk water, it could possibly concentrate on the floor 474 immediately below and around the lower end of the dispenser 400. This build-up of chlorine concentrate on the floor can lead to bleaching of coloured full surfaces such as Marbelite™ surfaces.

Such a potential problem is addressed with the dispenser 400. In the dispenser 400, the secondary apertures 426, 442 and 428, 444 are located some distance from the swimming pool floor (when the dispenser is at the first level) since they are located closer to the upper end of the dispenser body 402. Additionally, when the dispenser 400 is located at the first level its primary aperture 420 will be closed off as hereinbefore described. It is believed that these measures will aid in providing adequate dispersion of any concentrated chlorine solution that is formed when the pool pump is not running since such concentrated solution can only be dispensed by the dispenser 10 through apertures which are thus located some distance from the pool floor. Thus, staining or bleaching of the pool floor will not readily occur.

Referring to FIG. 19, reference numeral 500 generally indicates a chemical dispenser according to a second embodiment of the invention.

Parts of the chemical dispenser 500 which are the same or similar to those of the chemical dispenser 400 of FIGS. 15 to 18, are indicated with the same reference numerals.

The body 402 of the chemical dispenser 500 includes a cylindrical wall 502, with the annular end piece 410 and the valve means 460, while not shown in FIG. 19, provided at the lower end of the wall 502.

At the upper end of the wall 502, there is provided an inwardly curved inwardly protruding annular component 504, with a cylindrical component 506 protruding operatively upwardly from the inner edge of the component 504. The upper end of the cylindrical component 506 is provided with the end cap 432 and aperture 434. The cylindrical component 506 houses the polystyrene block 448.

The dispenser 500 does not have the secondary openings 426, 428, 442, 444 and 446. Instead, it has two groups of diametrically opposed secondary openings 508, 510 in the annular component 504. Each group of secondary openings thus comprises the two peripherally spaced secondary openings 508, 510, which are each typically 10 mm in diameter. The openings 508, 510 are thus upwardly directed in use, when the dispenser 500 is located uprightly in water. The openings 508, 510 will initially be closed off with removable soft pliable plastics plugs (not shown) with a user then removing the appropriate number of plugs to obtain the desired degree of chlorine dosage.

The dispenser 500 also includes a water treatment substance package 480 (not shown) located within the cavity 452 defined by the wall 502. However, an additional loose tablet 482, resting on top of the package 480, is also provided.

The upwardly directed secondary openings 508, 510 provide the advantages of chlorine being released even further from the pool floor than in the case of the dispenser 400, when the dispenser is in its first position on the pool floor. Furthermore, the openings 508, 510 will be even less prone to blockage with inerts than the secondary openings of the dispenser 400, since inerts will naturally be inclined to drop downwardly from the openings 508, 510 into the cavity 452.

In the dispenser 500, the polystyrene block 448 is concentrated in a smaller diameter centrally located zone, which provides an increased leverage force for keeping the dispenser upright at the bottom of the pool, as well as reducing the volume of the polystyrene block—this decreases the buoyancy of the dispenser 500 as compared to that of the dispenser 400 so that the dispenser 500 will remain at the bottom of the pool for a longer period.

The additional loose tablet 482 promotes chlorine dosage through the secondary openings 508, 510 bearing in mind that, since the secondary openings 508, 510 are upwardly directed, it is necessary first to create a saturated chlorine solution in the cavity 452 before dosage through the secondary openings 508, 510 will commence. The loose unprotected tablet 482 will dissolve quickly to provide such a saturated solution, and will thus provide an initial chlorine dosage boost at the bottom of the pool. This additional tablet can typically have a mass of 50-100 gm.

The Applicant believes that use of the dispensers 400, 500 will give rise to similar significant advantages as compared to existing means of dosing swimming pools with chlorine, such as surface floating chlorine dispensers, as do the dispensers 10, 50, 100 and 200 hereinbefore described.

As in the case of the dispensers 10, 50, 100 and 200, the dispensers 400, 500 present a compromise between the desirability of dispensing chlorine deep inside a swimming pool and the difficulty of maintaining adequate chlorination throughout the life of the dispenser, while still maintaining acceptable levels of convenience for the user. Thus, the dispensers 400, 500 release only part of their chlorine near the floor of the pool, before surfacing and releasing the remainder near the surface.

The Applicant believes that the dispensers 400, 500 are particularly suited for use in dispensing chlorine into a swimming pool in which they are located. It is believed that the dispensers 400, 500 will last for 3 to 5 weeks before the tablets are exhausted. Calcium hypochlorite is rapid dissolving but leaves inert residues. These residues can be problematic with long lasting dispensers due to crystallization/blocking of dispensing openings, resulting in low or inconsistent chlorine release. Such residues are trapped on top of the first and second annular members 410, 414 and in the central component 464 of the valve cap 462. Another problem with calcium hypochlorite is the variability in the consistency of the raw material itself, which introduces variability into the rate of dissolution in different batches of material. It is believed that this problem is overcome with the dispensers 500, 500.

It is thus believed that the dispensers 400, 500 overcomes, or at least address, key problems with calcium hypochlorite based floaters, and which relates to the variability of the raw material itself as well as the variability introduced by different environmental conditions. This has primarily been achieved through greater control over the contact area where the water meets the calcium hypochlorite, ie at the tablet surfaces. Thus, in the packages 480, the sleeve or wrapper 486 prevents any water contact with the sides of the tablets, except through the openings 488. Thus, the surface contact area between the water and the tablets is strictly regulated, thereby giving control over this important variable.

It is believed that control is also achieved by virtue thereof that the secondary openings are located at the correct level, so that chlorinated water travels directly from the surfaces of the tablets through the openings into the main body of water to be treated.

It is believed that the side openings 490 in the package 488, further assist in eliminating variability of chlorine dosage. The openings 490 are sufficiently large not to clog up and to permit lateral water access onto the tablets, which assists in ongoing dissolution of chlorine into the water. Furthermore, the number of openings 490 can be varied according to the time of year. Thus, in winter when dissolution is slow due to the low water temperature, typically 8 to 14 of the openings 490 may be provided, while in summer, when the water temperature is higher and dissolution is faster, 2 to 8 of the openings 490 will suffice. Thus, by means of the openings 490, and in particular by varying the number of openings 490, a mechanism is provided by means of which vast differences in summer and winter pool conditions can be addressed at the point of manufacture of the dispensers 400, 500.

The Applicant thus believes that, by virtue of the openings 490, as well as the adjustability of the effective open areas of the secondary openings, the dispenser 400 will address climatic variations as well as pool/bather variability.

It is further believed that consistency is achieved with the dispensers 400, 500, since, in the package 480, the sleeve 486 inhibits tablet swelling through lateral expansion, and also eliminates the risk of the secondary apertures becoming blocked through crystallization or accumulation of undissolved inerts.

Apart from being used to adjust chlorine dosage, the secondary openings, which are relatively large, will not be prone to blockage with inerts. Still further, the large secondary openings lead to good performance as hereinbefore described, and are also convenient to a consumer, since they do not require the cutting off of nodules to create openings, before the dispensers are used.

The dispensers 400, 500 are also relatively inexpensive to manufacture and, as emerges from what is set out above, easy to use.

Additionally, due to the manner in which the openings 490 are arranged, ie on one side only of the package 480, the sleeve 486 protects the tablets from the water as long as possible. If the holes 490 were to be evenly spaced around the sleeve 486, there would be a risk, as the tablets dissolve away from the surface of the sleeve, of tablet contact area with the sleeves 486 being diminished. For example, if the tablets were eroded from all sides, ie if the holes 490 were spaced evenly around the sleeve 486, after a while the weight of the tablets would make them collapse in a heap at the bottom of the sleeve, rendering them vulnerable to water agitation. By arranging the openings 490 in two rows spaced 20° to 50° apart, water erosion takes places in only 1 segment of each package. There thus remains sufficient contact area between the sleeve and the tablets to hold them in place and to protect them for an extended period of time.

1. A method of treating water, which method includes
introducing a chemical dispenser containing a water treatment substance, into a body of water so that the dispenser is located at a first level in the water;
allowing water to enter the dispenser through a secondary aperture so that the water comes into contact with the water treatment substance, with an active ingredient being released into the water, thereby dispensing active ingredient into the body of water at the first level;
continuing the dispensing of active ingredient into the body of water at the first level for a period of time;
preventing water from entering or leaving the dispenser through an operatively lower primary aperture, while the dispenser is at the first level;
thereafter, allowing the dispenser to rise to a second higher level in the body of water; and
for a further period of time, permitting water also to enter or leave the dispenser through the primary aperture, thereby dispensing active ingredient from the dispenser into the body of water at the second level.

2. A method according to claim 1, wherein the body of water is contained in a reservoir, with the first level being in proximity to a floor of the reservoir, and the second level being in proximity to the surface of the water in the reservoir.

3. A method according to claim 1, wherein the dispenser is of elongate form, with the method including orientating it vertically, or allowing it to orientate vertically, in the water at the first and second levels.

4. A method according to claim 1, wherein the primary aperture is closed off with a closure member which moves from a closed position in which it closes off the primary aperture, to an open position in which the primary aperture is exposed, as the dispenser moves from the first level to the second level.

5. A method according to claim 1, wherein the periods of time that the active ingredient is dispensed into the water at the first and second levels is, in each case, at least several days.

6. A method according to claim 1, which includes, at the second level, also dispensing a conditioning agent from the dispenser into the body of water.

7. A method according to claim 6, wherein the period of time that the active ingredient is dispensed into the water at the first level is less than 5 hours, while the period of time that it is dispensed at the second level is less than 10 hours.

8. A chemical dispenser for dispensing an active ingredient into water, the chemical dispenser including
a hollow elongate buoyant dispenser body having an operatively lower first end portion and an operatively upper second end portion, and providing an enclosed cavity;
an operatively downwardly directed primary aperture at the first end of the dispenser body;
at least one secondary aperture which provides access to the cavity, or at least one secondary aperture defining means;
valve means for closing off the primary aperture when the dispenser is located at a first low level in a body of water, but allowing the primary aperture to be exposed or uncovered when the dispenser is at a second higher level in the body of water; and
a water treatment substance inside the dispenser body cavity, with the cavity containing sufficient water treatment substance such that the dispenser sinks when introduced into water.

9. A chemical dispenser according to claim 8, which includes buoyancy imparting means at or near the operatively upper second end portion of the dispenser body.

10. A chemical dispenser according to claim 9, wherein the dispenser body includes a sleeve-like or cylindrical portion, between the first and second end portions, with the water treatment substance being in the form of at least one tablet located inside the cylindrical portion which thus has sufficient mass so that the dispenser sinks when introduced into water.

11. A chemical dispenser according to claim 10, wherein the valve means comprises an externally located plug for closing off the primary aperture, a stem protruding from the plug through the primary aperture into the inside of the container body, and a retaining component protruding from the stem, for holding the plug and stem captive relative to the dispenser body.

12. A chemical dispenser according to claim 10, which includes a plurality of primary water treatment substance tablets, with the primary tablets being stacked one above the other inside the cylindrical portion of the dispenser body, in proximity to its first end portion, as well as a plurality of secondary water treatment substance tablets, which are smaller than the primary tablets, and which are located between the primary tablets and the buoyancy imparting means.

13. A chemical dispenser according to claim 10, wherein the valve means comprises openable closure means closing off the primary aperture, and bias means biasing the closure means into contact with a first end piece closing off the first end of the cylindrical portion, thereby to seal off the primary aperture, with the bias means being associated with the tablet so that, in use, as the tablet is consumed, the bias imparted by the bias means on closure means reduces.

14. A chemical dispenser according to claim 13, wherein the closure or valve means comprises an externally located closure member closing off the primary aperture; a stem protruding from the closure member through the primary aperture into the inside of the container body and through an aperture in the tablet; and a retaining component at the free or distal end of the stem, for trapping the distal end of the stem inside the dispenser body.

15. A chemical dispenser according to claim 14, wherein the bias means is provided between the retaining component of the closure means and the operatively upper surface of the tablet, and is such that it urges the retaining component away from the tablet.

16. A chemical dispenser according to claim 13, wherein the bias means is in the form of a spring, and which includes a plurality of primary water treatment substance tablets, with the primary tablets being stacked one above the other inside the cylindrical portion of the dispenser body, in proximity to its first end portion, as well as a plurality of secondary water treatment substance tablets, which are smaller than the primary tablets, and which are located between the primary tablets and the buoyancy imparting means.

17. A chemical dispenser according to claim 16, wherein the closure or valve means comprises an externally located closure member closing off the primary aperture; a stem protruding from the closure member through the primary aperture into the inside of the container body and through aligned apertures in a plurality of the primary tablets; a spring bearing member around the stem and resting on an operatively upper surface of the lowermost primary tablet(s), with the spring bearing member and the stem being movable relative to each other; a cap or end piece attached to the distal end of the stem, with the cap or end piece also located within the apertures or central openings of the primary tablets; and with the spring being located around the stem and sandwiched between the cap or end piece and the spring bearing member, and being under compression.

18. A chemical dispenser according to claim 8, which includes a water conditioning agent inside the dispenser body, with sufficient water treatment substance and water conditioning agent initially being present inside the dispenser body so that the dispenser sinks when introduced into water, but with the dispenser body having sufficient buoyancy so that it will float at the water surface while it still contains some water treatment substance and water conditioning agent.

19. A chemical dispenser according to claim 18, wherein the dispenser body includes a sleeve-like or cylindrical portion, between the first and second end portions, with the water treatment substance being in particulate form and being contained within a first perforated bag located in the cylindrical portion, and the water conditioning agent also being in particulate form and being contained within a second perforated bag also located in the cylindrical portion, below the first perforated bag.

20. A chemical dispenser according to claim 19, wherein the valve means comprises an externally located plug for closing off the primary aperture, a stem protruding from the plug through the primary aperture into the inside of the container body, and a retaining component protruding from the stem, for holding the plug and stem captive relative to the dispenser body.
